(19) United States
(12) Patent Application Publication
(10) Pub. No.: US 2025/0058157 A1
(43) Pub. Date: Feb. 20, 2025

(54) WILDFIRE ELIMINATION SYSTEM

(71) Applicants: Alfonso Moscozo, Hemet, CA (US); Nancy Estrada-Moscozo, Hemet, CA (US)

(72) Inventors: Alfonso Moscozo, Hemet, CA (US); Nancy Estrada-Moscozo, Hemet, CA (US)

(21) Appl. No.: 18/233,764

(22) Filed: Aug. 14, 2023

(51) Int. Cl. A62C 3/02; A62C 35/02

(52) U.S. Cl. CPC A62C 3/0214; A62C 3/0271; A62C 35/023

(57) ABSTRACT

A wildfire elimination system removably connected to at least a portion of a building, the wildfire elimination system including a fire deterrent dispenser device to dispense at least one fire retardant therefrom to eliminate a fire, a plurality of sensors connected to the fire deterrent dispenser device to detect a presence of a fire within a predetermined distance at least one of the plurality of sensors and automatically control the fire deterrent dispenser device based on the presence of the fire, a fire retardant storage container connected to the fire deterrent dispenser device to store the at least one fire retardant therein, and an extraction device connected to the fire retardant storage container to extract the at least one fire retardant from the fire retardant storage container using at least one extraction tool.

The plurality of sensors may include at least one exterior heat sensor removably connected to at least a portion of an exterior of the building and configured to detect another temperature level based on another predetermined temperature level that indicates a fire near the building is imminent. The wildfire elimination system may further include a fire resistant pipe comprising a plurality of apertures, the fire resistant pipe disposed within at least a portion of the building to dispense the at least one fire retardant from the plurality of apertures in response to at least one of the plurality of sensors detecting the fire within the building.

### BACKGROUND

### 1. Field

The present general inventive concept relates generally to fire prevention, and particularly, to a wildfire elimination system.

### 2. Description of the Related Art

A wildfire is an uncontrolled and unpredictable fire in an area filled with vegetation. In some areas, naturally occurring wildfires can be beneficial to an environment. However, in other areas, where wildfires are uncommon, it can be a natural disaster and highly dangerous to the environment in which it occurs.

In some areas that prone to drought, thousands of properties are lost due to wildfires, which pose a serious risk to human life. Many people rely on firefighters and/or other volunteers to help control or eliminate the wildfire. Unfortunately, by the time the wildfire is controlled, the damage has already been done.

Therefore, there is a need for a wildfire elimination system that automatically controls fire prevention when needed.

### SUMMARY

The present general inventive concept provides a wildfire elimination system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wildfire elimination system removably connected to at least a portion of a building, the wildfire elimination system including a fire deterrent dispenser device to dispense at least one fire retardant therefrom to eliminate a fire, a plurality of sensors connected to the fire deterrent dispenser device to detect a presence of a fire within a predetermined distance at least one of the plurality of sensors and automatically control the fire deterrent dispenser device based on the presence of the fire, a fire retardant storage container connected to the fire deterrent dispenser device to store the at least one fire retardant therein, and an extraction device connected to the fire retardant storage container to extract the at least one fire retardant from the fire retardant storage container using at least one extraction tool.

The plurality of sensors may detect at least one of a temperature level within the predetermined distance, smoke within the predetermined distance, and flame on the building.

The plurality of sensors may control the fire deterrent dispenser device based on at least one of a location of the fire, a proximity of the fire, and a severity of the fire.

The extraction device may use at least one of a weighted block, a gas canister, and an air compressor to extract the at least one fire retardant from the fire retardant storage container.

The plurality of sensors may include at least one exterior heat sensor removably connected to at least a portion of an exterior of the building and configured to detect another temperature level based on another predetermined temperature level that indicates a fire near the building is imminent.

The wildfire elimination system may further include a fire resistant pipe comprising a plurality of apertures, the fire resistant pipe disposed within at least a portion of the building to dispense the at least one fire retardant from the plurality of apertures in response to at least one of the plurality of sensors detecting the fire within the building.

The wildfire elimination system may further include a storage vault disposed within a ground surface to store the fire retardant storage container therein, and an extraction vault disposed within the ground surface to store the extraction device therein.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an elevational side sectional view of a wildfire elimination system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Wildfire Elimination System 100
Fire Deterrent Dispenser Device 110
Sensors 120
Smoke and Heat Sensor 121
Exterior Heat Sensor 122
Fire Retardant Storage Container 130
Extraction Device 140
Delivery Conduit 150
Fire Resistant Pipe 151
Transfer Conduit 160
Storage Vault 170
Storage Body 171
Storage Barrier 172
Extraction Vault 180
Extraction Body 181
Extraction Barrier 182
Power Source 190

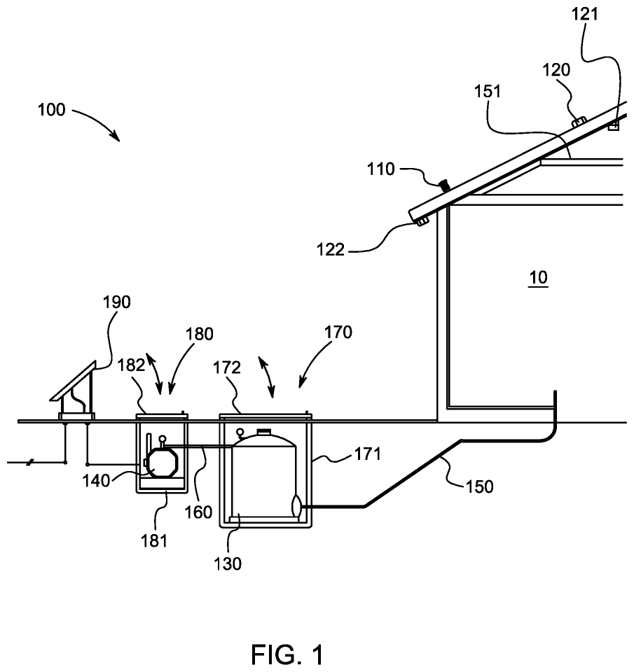

FIG. 1 illustrates an elevational side sectional view of a wildfire elimination system 100, according to an exemplary embodiment of the present general inventive concept.

The wildfire elimination system 100 may be constructed from at least one of metal, plastic, wood, glass, and rubber, etc., but is not limited thereto.

The wildfire elimination system 100 may include a fire deterrent dispenser device 110, a plurality of sensors 120, a fire retardant storage container 130, an extraction device 140, a delivery conduit 150, a transfer conduit 160, a storage vault 170, an extraction vault 180, and a power source 190, but is not limited thereto.

The fire deterrent dispenser device 110 may include a sprinkler, a hose, a nozzle, and a power jet, but is not limited thereto.

The fire deterrent dispenser device 110 may be removably connected to at least a portion of a building 10 (e.g., a house, a hotel, a store, an office, etc.). Also, the fire deterrent dispenser device 110 may move (i.e., rotate, pivot) in any direction. The fire deterrent dispenser device 110 may dispense (i.e., spray, eject, shoot) at least one fire retardant therefrom. For example, the fire deterrent dispenser device 110 may dispense water, huntite, hydromagnesite, aluminum hydroxide, magnesium hydroxide, organic halide, fire retardant foams, and/or fire retardant gels. Thus, the fire deterrent dispenser device 110 may eliminate and/or prevent a fire and/or a wildfire.

Each of the plurality of sensors 120 may include a heat sensor, a temperature sensor, a smoke sensor, and a flame sensor, but is not limited thereto. Also, the plurality of sensors 120 may further include a processing unit (e.g., a processor, a microprocessor, a microcontroller).

The plurality of sensors 120 may be removably connected to at least a portion of the building 10. The plurality of sensors 120 may detect a presence of a fire (i.e., a flame), such as a temperature level within a predetermined distance (e.g., twenty feet, one hundred feet, one mile, ten miles, twenty mils, etc.) of each of the plurality of sensors 120 and/or the building 10. The processing unit of the plurality of sensors 120 may activate the fire deterrent dispenser device 110 in response to determining the temperature level exceeds a predetermined temperature level that indicates a fire is within the predetermined distance. In other words, the fire deterrent dispenser device 110 may be controlled by the processing unit of the plurality of sensors 120 based on a location of the fire, a proximity of the fire, and/or a severity (e.g., spread of fire, speed of movement of the fire) of the fire. Alternatively, and/or in addition thereto, the plurality of sensors 120 may detect smoke and/or flame that has already reached the building 10.

Accordingly, the processing unit of the plurality of sensors 120 may automatically direct the fire deterrent dispenser device 110 to move (i.e., rotate, pivot) to dispense the at least one fire retardant toward the fire.

Furthermore, the plurality of sensors 120 may include a smoke and heat sensor 121 and at least one exterior heat sensor 122, but is not limited thereto.

The smoke and heat sensor 121 may be removably connected within at least a portion of an interior of the building 10, such as an attic, a crawl space, and/or any other empty room. The smoke and heat sensor 121 may activate the fire deterrent dispenser device 110 in response to determining the temperature level exceeds the predetermined temperature level that indicates the fire is within the predetermined distance of the building 10 (e.g., a wildfire). Moreover, the smoke and heat sensor 121 may detect the smoke is within the predetermined distance of the building 10.

Additionally, the fire deterrent dispenser device 110 may dispense the at least one fire retardant therefrom into a location of the smoke and heat sensor 121, such as the attic, the crawl space, and/or any other empty room based on where the fire is detected.

The at least one exterior heat sensor 122 may be removably connected to at least a portion of an exterior of the building 10. The at least one exterior heat sensor 122 may be configured to detect another temperature level based on another predetermined temperature level that indicates a fire near the building 10 is imminent, such as the fire being within five feet and/or ten feet. In other words, the at least one exterior heat sensor 122 may have a different sensitivity level to temperature compared to the plurality of sensors 120. Moreover, the at least one exterior heat sensor 122 may activate the fire deterrent dispenser device 110 in response to determining the another temperature level exceeds the another predetermined temperature level. Also, the at least one exterior heat sensor 122 may activate the fire deterrent dispenser device 110 prior to the fire deterrent dispenser device 110 being activated by the plurality of sensors 120.

Each of the plurality of sensors 120 may have an alarm connected thereto. For example, the plurality of sensors 120 may have three alarms. In other words, the triggering of the alarms may activate the fire deterrent dispenser device 110 based on the detection of each of the plurality of sensors 120 as discussed above.

The fire retardant storage container 130 may be disposed within at least a portion of a ground surface (i.e., underground). The fire retardant storage container 130 may store the at least one fire retardant (e.g., water, huntite, hydromagnesite, aluminum hydroxide, magnesium hydroxide, organic halide, fire retardant foams, and/or fire retardant gels) therein.

The extraction device 140 may include a weighted block, a gas canister (e.g., carbon dioxide filled canister), and an air compressor, but is not limited thereto.

The extraction device 140 may be disposed within at least a portion of the ground surface. The extraction device 140 may extract the at least one fire retardant from the fire retardant storage container 130 using at least one extraction tool (e.g., retardant extraction tool). In using the weighted block, the extraction device 140 may propel weighted block into the fire retardant storage container 130 to extract the at least one fire retardant. In using the gas canister, the extraction device 140 may use highly compressed gas to extract the at least one fire retardant. Lastly, in using the air compressor, the extraction device 140 may using a fan and/or turbine to inject air into the fire retardant storage container 130 until the fire deterrent dispenser device 110 is activate by the processing unit of the plurality of sensors 120. Accordingly, the potential energy of air trapped within the fire retardant storage container 130 may extract the at least one fire retardant to the fire deterrent dispenser device 110.

The delivery conduit 150 may be constructed of fire resistance material and capable of withstanding a predetermined pressure level (e.g., on hundred pounds per square inch).

The delivery conduit 150 may connect the fire deterrent dispenser device 110 to the fire retardant storage container 130. The delivery conduit 150 may transfer the at least one fire retardant from the fire retardant storage container 130 to the fire deterrent dispenser device 110.

Also, the delivery conduit 150 may include a fire resistant pipe 151, but is not limited thereto.

The fire resistant pipe 151 may be disposed within at least a portion of the building 10, such as the attic, the crawl space, and/or any other empty space. The fire resistant pipe 151 may be perforated (i.e., have apertures thereon) to dispense the at least one fire retardant therethrough. As such, the fire resistant pipe 151 may operate as a type of the fire deterrent dispenser due to dispensing the at least one fire retardant therefrom. Also, the fire resistant pipe 151 may dispense the at least one fire retardant therefrom into the location of the smoke and heat sensor 121, such as the attic, the crawl space, and/or any other empty room based on where the fire is detected.

The transfer conduit 160 may connect the fire retardant storage container 130 to the extraction device 140. The transfer conduit 160 may receive the at least one extraction tool from the extraction device 140 to the fire retardant storage container 130.

The storage vault 170 may include a storage body 171 and a storage barrier 172, but is not limited thereto.

The storage body 171 may be constructed of concrete, metal, plastic, and/or any other durable material. Also, the storage body 171 may be fireproof. The storage body 171 may be removably disposed (i.e., installed) within the ground surface (i.e., underground). The storage body 171 may store the fire retardant storage container 130 therein.

The storage barrier 172 may include a door and a hatch, but is not limited thereto.

The storage barrier 172 may be fireproof. The storage barrier 172 may be movably (i.e., hingedly, rotatably) disposed on at least a portion of the storage body 171. The storage barrier 172 may move (i.e., rotate) from closed on the storage body 171 in a first position to at least partially opened away from the storage body 171 in a second position. Conversely, the storage barrier 172 may move from opened away from the storage body 171 in the second position to closed on the storage body 171 in the first position. In other words, the storage barrier 172 may allow prevent access within the storage body 171 while closed and allow access within the storage body 171 while opened.

The extraction vault 180 may include an extraction body 181 and an extraction barrier 182, but is not limited thereto.

The extraction body 181 may be constructed of concrete, metal, plastic, and/or any other durable material. Also, the extraction body 181 may be fireproof. The extraction body 181 may be removably disposed (i.e., installed) within the ground surface (i.e., underground). The extraction body 181 may store the extraction device 140 therein.

The extraction barrier 182 may include a door and a hatch, but is not limited thereto.

The extraction barrier 182 may be fireproof. The extraction barrier 182 may be movably (i.e., hingedly, rotatably) disposed on at least a portion of the extraction body 181. The extraction barrier 182 may move (i.e., rotate) from closed on the extraction body 181 in a first position to at least partially opened away from the extraction body 181 in a second position. Conversely, the extraction barrier 182 may move from opened away from the extraction body 181 in the second position to closed on the extraction body 181 in the first position. In other words, the extraction barrier 182 may allow prevent access within the extraction body 181 while closed and allow access within the extraction body 181 while opened.

The power source 190 may include a solar cell, a battery, and a power inlet, but is not limited thereto.

The power source 190 may be connected to at least a portion of the extraction device 140. The power source 190 may provide power to the extraction device 140. The solar cell and/or the battery of the power source 190 provide backup power in event of a power outage from an external power source (e.g., a utility company).

Therefore, the wildfire elimination system 100 may automatically eliminate a wildfire detected within the predetermined distance of the building 10. Also, the wildfire elimination system 100 may protect the building without relying on assistance from a first responder (e.g., police, fire department).

The present general inventive concept may include a wildfire elimination system 100 removably connected to at least a portion of a building 10, the wildfire elimination system 100 including a fire deterrent dispenser device 110 to dispense at least one fire retardant therefrom to eliminate a fire, a plurality of sensors 120 connected to the fire deterrent dispenser device 110 to detect a presence of a fire within a predetermined distance at least one of the plurality of sensors 120 and automatically control the fire deterrent dispenser device 110 based on the presence of the fire, a fire retardant storage container 130 connected to the fire deterrent dispenser device 110 to store the at least one fire retardant therein, and an extraction device 140 connected to the fire retardant storage container 130 to extract the at least one fire retardant from the fire retardant storage container 130 using at least one extraction tool.

The plurality of sensors 120 may detect at least one of a temperature level within the predetermined distance, smoke within the predetermined distance, and flame on the building 10.

The plurality of sensors 120 may control the fire deterrent dispenser device 110 based on at least one of a location of the fire, a proximity of the fire, and a severity of the fire.

The extraction device 140 may use at least one of a weighted block, a gas canister, and an air compressor to extract the at least one fire retardant from the fire retardant storage container 130.

The plurality of sensors 120 may include at least one exterior heat sensor 122 removably connected to at least a portion of an exterior of the building 10 and configured to detect another temperature level based on another predetermined temperature level that indicates a fire near the building 10 is imminent.

The wildfire elimination system 100 may further include a fire resistant pipe 151 comprising a plurality of apertures, the fire resistant pipe 151 disposed within at least a portion of the building 10 to dispense the at least one fire retardant from the plurality of apertures in response to at least one of the plurality of sensors 120 detecting the fire within the building 10.

The wildfire elimination system 100 may further include a storage vault 170 disposed within a ground surface to store the fire retardant storage container 130 therein, and an extraction vault 180 disposed within the ground surface to store the extraction device 140 therein.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wildfire elimination system removably connected to at least a portion of a building, the wildfire elimination system comprising:
a fire deterrent dispenser device to dispense at least one fire retardant therefrom to eliminate a fire;
a plurality of sensors connected to the fire deterrent dispenser device to detect a presence of a fire within a predetermined distance at least one of the plurality of sensors and automatically control the fire deterrent dispenser device based on the presence of the fire;
a fire retardant storage container connected to the fire deterrent dispenser device to store the at least one fire retardant therein; and
an extraction device connected to the fire retardant storage container to extract the at least one fire retardant from the fire retardant storage container using at least one extraction tool.

2. The wildfire elimination system of claim 1, wherein the plurality of sensors detect at least one of a temperature level within the predetermined distance, smoke within the predetermined distance, and flame on the building.

3. The wildfire elimination system of claim 1, wherein the plurality of sensors control the fire deterrent dispenser device based on at least one of a location of the fire, a proximity of the fire, and a severity of the fire.

4. The wildfire elimination system of claim 1, wherein the extraction device uses at least one of a weighted block, a gas canister, and an air compressor to extract the at least one fire retardant from the fire retardant storage container.

5. The wildfire elimination system of claim 1, wherein the plurality of sensors comprises:
at least one exterior heat sensor removably connected to at least a portion of an exterior of the building and configured to detect another temperature level based on another predetermined temperature level that indicates a fire near the building is imminent.

6. The wildfire elimination system of claim 1, further comprising:
a fire resistant pipe comprising a plurality of apertures, the fire resistant pipe disposed within at least a portion of the building to dispense the at least one fire retardant from the plurality of apertures in response to at least one of the plurality of sensors detecting the fire within the building.

7. The wildfire elimination system of claim 1, further comprising:
a storage vault disposed within a ground surface to store the fire retardant storage container therein; and
an extraction vault disposed within the ground surface to store the extraction device therein.
